(19) United States
(12) Patent Application Publication
(10) Pub. No.: US 2005/0094986 A1
(43) Pub. Date: May 5, 2005

(54) Information recording/reproduction apparatus, information recording/reproduction program and an information recording medium on which the information recording/reproduction program is recorded

(75) Inventors: Seiji Miyazaki, Tokorozawa-shi (JP); Shinji Hatakeyama, Tokorozawa-shi (JP); Shinichiro Sakamoto, Tokorozawa-shi (JP); Masaaki Tanaka, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/951,786

(22) Filed: Sep. 29, 2004

(30) Foreign Application Priority Data
Sep. 30, 2003 (JP) P2003-341485

(51) Int. Cl. H04N 5/781

(52) U.S. Cl. 386/125; 386/126

(57) ABSTRACT

An information recording/ reproduction apparatus which is provided with a hard disc as a first recording medium that constantly records recording information that is input from the outside, and a HD drive as a first reproduction device which reproduces at least the aforementioned information while recording it in the first recording area, or information that was recorded in the first recording area, as well as provided with a hard disc as a second recording medium on which related information that is related to the information recording/reproduction apparatus itself, a HD drive as a recording device which records the aforementioned related information on the second recording medium, an input unit or remote control unit as a specification device that is used for specifying the related information to be reproduced, and an HD drive as a second reproduction device which reproduces the specified related information from the second recording medium.

### BACKGROUND OF THE INVENTION

1. Field of the Invention

This invention is related to an information recording/reproduction apparatus, information recording/reproduction method, information recording/reproduction program and an information recording medium on which the information recording/reproduction program is recorded, and more particularly to an information recording/reproduction apparatus, information recording/reproduction method, information recording/reproduction program and an information recording medium on which the information recording/reproduction program is recorded that records a program of a television broadcast, which is obtained by way of a broadcast signal, onto a recording medium such as an optical disc or hard disc.

2. Description of the Related Art

Conventionally, information such as a broadcast program has been recorded on a hard disc or the like that is fixed in a so-called HDD (hard disc drive).

This HDD apparatus is normally equipped with an instruction manual or explanation video that explains how to use this HDD apparatus. The user uses the HDD apparatus according to the explained method of use.

However, when supplying the descriptions of the instruction manual or explanation video that explains how to use the HDD apparatus, it is supplied as another component appended to the main part of HDD apparatus. Therefore, when shipping the HDD apparatus as a product, independent management of the descriptions of these use method has been needed. Moreover, a user needs to manage the descriptions of the instruction manual or explanation video independently with the main part of HDD apparatus. However, by the danger of losing them or making them damage, when using the HDD apparatus, there are inconveniences that the user can not understand how to use it.

### SUMMARY OF THE INVENTION

Taking into consideration the inconvenience mentioned above, the object of this invention is to provide an information recording/reproduction apparatus, information recording/reproduction program and an information recording medium on which the information recording/reproduction program is recorded which are capable of immediate supplying the information concerning how to use the HDD apparatus when a user wants to know the usage of the information recording/reproduction apparatus.

The above object of the present invention can be achieved by an information recording/reproduction apparatus of the present invention. The information recording/reproduction apparatus is provided with: a first recording area on a recording medium that constantly records recording information input from the outside; a first reproduction device which reproduces at least the information while recording it in the first recording area, or information that was recorded in the first recording area; a second recording area on the recording medium in which information related to the information recording/reproduction apparatus itself is recorded; a recording device which records the related information into the second recording area; a specification device which is used for specifying the related information to be reproduced; and a second reproduction device which reproduces the specified related information from the second recording area.

According to the present invention, information related to the information recording/reproduction apparatus itself is integrated with and stored on a hard disc in the information recording/reproduction apparatus, so it is not necessary to provide information related to the information recording/reproduction apparatus on a separate medium, and thus there is no materials cost for the separate medium. Also, in the case of a separate medium, a storage place was necessary, however, there is no need for a storage place for a separate medium. Furthermore, in the case of providing information related to the information recording/reproduction apparatus itself on a separate medium, there was the chance that the separate medium could be lost. However, in this case it is not necessary to look for the separate medium.

In one aspect of the present invention can be achieved by the information recording/reproduction apparatus of the present invention. The information recording/reproduction apparatus of the present invention is, wherein the related information is image information.

According to the present invention, the information related to the information recording/reproduction apparatus is provided as images, so it is possible to provide information to the operator that is more detailed and easier to understand than through documents such as manuals.

In another aspect of the present invention can be achieved by the information recording/reproduction apparatus of the present invention. The information recording/reproduction apparatus of the present invention is, wherein the related information includes information for checking the function of the information recording/reproduction apparatus, and is recorded together with the initialization information for initializing the first recording area in the second recording area.

According to the present invention, the information related to the information recording/reproduction apparatus is provided as audio, so it is possible to provide information to the operator that is more detailed and easier to understand than through documents such as manuals.

In further aspect of the present invention can be achieved by the information recording/reproduction apparatus of the present invention. The information recording/reproduction apparatus of the present invention is, wherein the related information includes advertisement information for the information recording/reproduction apparatus itself.

According to the present invention, function-check information for checking the product was written simultaneously with the initialization of the hard disc in the manufacturing process of the information recording/reproduction apparatus. Therefore, since the work on the manufacturing line for initializing the hard disc (or the work of copying software) is not performed separately from the work of writing function-check information, it is possible to shorten the manufacturing time, as well as simplify the work and lower the cost of manufacturing.

In further aspect of the present invention can be achieved by the information recording/reproduction apparatus of the present invention. The information recording/reproduction apparatus of the present invention is, wherein the related information includes information related to the operating method of the information recording/reproduction apparatus itself.

According to the present invention, by having an information recording/reproduction apparatus and image-display apparatus, it is possible to readily perform advertisement for the information recording/reproduction apparatus, so when a customer is attracted to purchasing the product, it is possible to effectively perform a presentation of the information recording/reproduction apparatus.

In further aspect of the present invention can be achieved by the information recording/reproduction apparatus of the present invention. The information recording/reproduction apparatus of the present invention is, wherein the related information includes information for repairing the information recording/reproduction apparatus.

According to the present invention, since it is not necessary to separately supply the operating method for the information recording/reproduction apparatus using documents or an external recording medium, shipping management of the product is simplified. Moreover, the user does not have to spend time looking for the documents of the like in which the operating method is recorded, so it becomes easier to check the operating method.

In further aspect of the present invention can be achieved by the information recording/reproduction apparatus of the present invention. The information recording/reproduction apparatus of the present invention is, wherein the related information includes information related to services that can be used by the operator of the information recording/reproduction apparatus.

According to the present invention, even when trouble with the information recording/reproduction apparatus occurs in the market, by referencing repair part information for the same model, it is possible to quickly identify the failed part.

The above object of the present invention can be achieved by an information recording/reproduction method of the present invention. The information recording/reproduction method that is executed by an information recording/reproduction apparatus that comprises a first recording area on a recording medium that constantly records recording information that is input from the outside; and a first reproduction device which reproduces at least the information while recording it in the first recording area, or information that was recorded in the first recording area, the method is provided with: a recording process of recording related information that is related to the information recording/reproduction apparatus itself in a second recording area on the recording medium where the related information is recorded; a specification process of specifying the related information to be reproduced; and a second reproduction process of reproducing the specified related information from the second recording area.

According to the present invention, information related to the information recording/reproduction apparatus itself is integrated with and stored on a hard disc in the information recording/reproduction apparatus, so it is not necessary to provide information related to the information recording/reproduction apparatus on a separate medium, and thus there is no materials cost for the separate medium. Also, in the case of a separate medium, a storage place was necessary, however, there is no need for a storage place for a separate medium. Furthermore, in the case of providing information related to the information recording/reproduction apparatus itself on a separate medium, there was the chance that the separate medium could be lost. However, in this case it is not necessary to look for the separate medium.

An information recording/reproduction program that causes a computer included in an information recording/reproduction apparatus that comprises a first recording area on a recording that constantly records recording information that is input from the outside; and a first reproduction device which reproduces at least the information while recording it in the first recording area, or information that was recorded in the first recording area, to function as a recording device which records related information that is related to the information recording/reproduction apparatus itself into a second recording area on the recording medium; a specification device which is used for specifying the related information to be reproduced; and a second reproduction device which reproduces the specified related information from the second recording area.

According to the present invention, information related to the information recording/reproduction apparatus itself is integrated with and stored on a hard disc in the information recording/reproduction apparatus, so it is not necessary to provide information related to the information recording/reproduction apparatus on a separate medium, and thus there is no materials cost for the separate medium. Also, in the case of a separate medium, a storage place was necessary, however, there is no need for a storage place for a separate medium. Furthermore, in the case of providing information related to the information recording/reproduction apparatus itself on a separate medium, there was the chance that the separate medium could be lost. However, in this case it is not necessary to look for the separate medium.

### BRIEF DESCRIPTION OF THE DRAWINGS

FIG. 1 is a block diagram showing the construction of the information recording/reproduction apparatus of an embodiment of this invention.

FIG. 2 is a flowchart showing the overall operation of a first embodiment of the invention.

FIG. 3 is a flowchart showing the overall operation of a second embodiment of the invention.

FIG. 4 is a flowchart showing the overall operation of a third embodiment of the invention.

FIG. 5 is a flowchart showing the overall operation of a fourth embodiment of the invention.

FIG. 6 is a flowchart showing the overall operation of a fifth embodiment of the invention.

FIG. 7 is a flowchart showing the overall operation of a sixth embodiment of the invention.

### DESCRIPTION OF THE PREFERRED EMBODIMENTS

Next, the preferred embodiments of the invention will be explained based on the drawings. The embodiments described below are embodiments in which the invention is applied to an information recording/reproduction apparatus that together with temporarily recording a broadcast program that was received via a broadcast signal onto a hard disc as information, later transfers and records that information onto a DVD (Digital Versatile Disc).

### (I) OVERALL CONSTRUCTION AND OPERATION

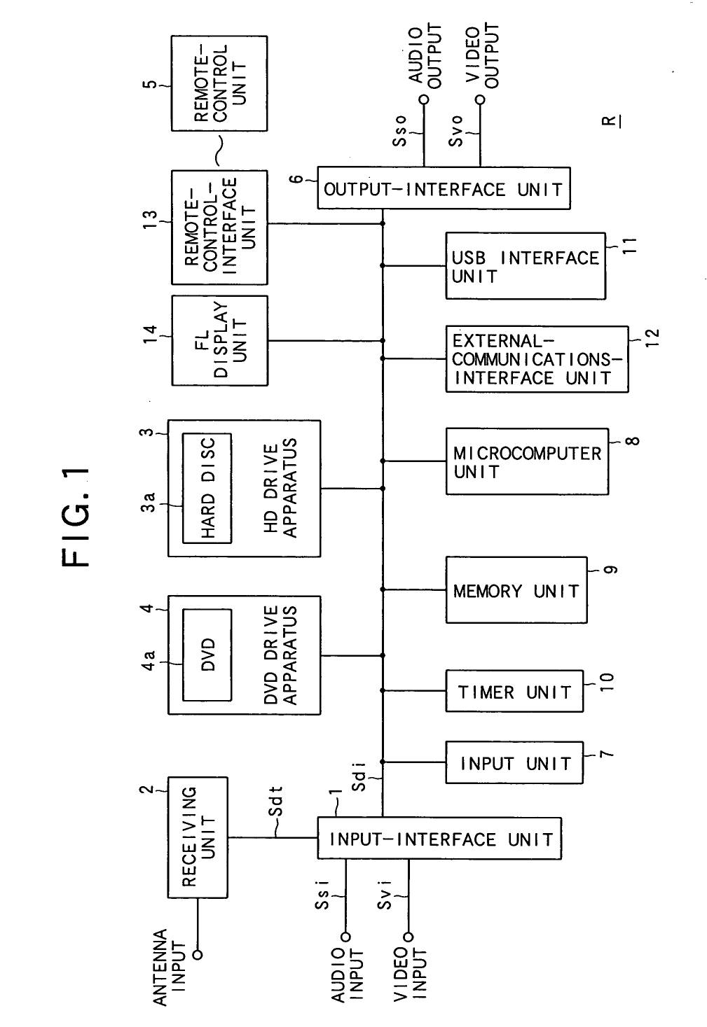

First, FIG. 1 will be used to explain the overall construction of the information recording/reproduction apparatus of the embodiments of the invention. FIG. 1 is a block diagram showing the construction of the information recording/reproduction apparatus of the embodiments of the invention.

As shown in FIG. 1, the information recording/reproduction apparatus R of the embodiments comprises: an input-interface unit 1, a receiving unit 2 to which an input signal that is received from an antenna or the like is input, an HD-drive apparatus 3 that is capable of recording information to or reproducing information from a fixed hard disc 3a as a temporary recording medium, a DVD-drive apparatus 4 that is capable of recording information to or reproducing information from a mounted DVD 4a as a removable recording medium, an output-interface unit 6, an input unit 7, a microcomputer unit 8, a memory unit 9, a timer unit 10, a USB (Universal Serial Bus) interface unit 11, a telephone-line-interface unit 12, a remote-control-interface unit 13, a FL (Fluorescent Light) display unit 14, and a remote-control unit 5.

Next, the overall operation will be explained. The information recording/reproduction apparatus of the embodiments is capable of receiving information (hereafter, this information will be referred to as the program) such as a broadcast program, which was received by way of a broadcast signal, and recording it onto either a hard disc 3a or DVD 4a, and is capable of detecting the recorded program from either one of these and reproducing it and outputting it to a display apparatus or speaker (not shown in the figures).

First, the overall operation in the case where the received program is recorded on a hard disc 3a will be explained.

The broadcast signal that carries the program to be received is received by the antenna, and after the receiving unit 2 performs processing such as demodulation, the signal is output to the input-interface unit 1 as a received signal Sdt.

Next, the input interface-interface unit 1 performs a preset input interface process on the received signal Sdt and generates a processed-received signal Sdi.

Also, the recording unit (not shown in the figures) in the HD-drive apparatus 3 records that processed-received signal Sdi onto the hard disc 3a. The received program is recorded onto the hard disc 3a in this way.

Next, the overall operation of the case where the received program is recorded onto a DVD 4a will be explained.

When recording the received program onto a DVD 4a, first, the receiving unit 2 and input-interface-unit 1 execute the same processes as in the case of recording the received program on the hard disc 3a described above, and then output the generated signal to the DVD-drive apparatus 4.

The recording unit (not shown in the figures) in the DVD-drive apparatus 4 records the generated signal onto the DVD 4a based on a control signal from the microcomputer unit 8. The received program is recorded onto a DVD 4a in this way.

Next, the overall operation when reproducing and outputting the information that is recorded on the hard disc 3a will be explained. When reproducing and outputting the information recorded on the hard disc 3a, first, the reproduction unit (not shown in the figures) in the HD-drive apparatus 3 detects the information recorded on the hard disc 3a according to a control signal from the microcomputer unit 8, then generates a detection signal and outputs it to the output-interface unit 6.

The output-interface unit 6 performs a preset output-interface process according to a control signal from the microcomputer unit 8 to generate an audio-output signal Sso and video-output signal Svo and outputs the signals to a display or speakers (not shown in the figures). The images or audio recorded on the hard disc 3a as information are reproduced in this way.

Finally, the overall operation when reproducing and outputting the information recorded on the DVD 4a will be explained.

When reproducing and outputting the information recorded on the DVD 4a, first, the reproduction unit (not shown in the figures) in the DVD-drive apparatus 4 detects the information recorded on the DVD 4a according to a control signal from the microcomputer unit 8 and generates a detection signal, then the output-interface unit 6 performs an output-interface process on the detection signal in the same way as in the case of reproducing and outputting information that is recorded on a hard disc 3a described above, and similarly generates an audio-output signal Sso and video-output signal Svo and outputs the signals to a display or speakers (not shown in the figures). Images and audio that are recorded on the DVD 4a are reproduced in this way.

Here, the control operation for controlling the overall operation described above is executed using the remote-control unit 5 or input unit 7 comprising a button-control unit, and the control-operation signal corresponding to the control operation performed from the input unit 7 or remote-control-interface unit 13 is output to the microcomputer unit 8.

The microcomputer unit 8, according to the control-operation signals, generates control signals for controlling the components of the information recording/reproduction apparatus R and outputs those signals to the respective components in order that the operations corresponding to the executed control operations are executed. Also, the information necessary for the processing by the microcomputer unit 8 is output to the memory unit 9 and stored temporarily, after which that information is read again from the memory unit 9 as needed and supplied for the processing by the microcomputer unit 8.

When transferring information from the hard disc 3a to the DVD 4a, the information is output from the HD-drive apparatus 3 to the DVD-drive apparatus 4 according to a control signal as described above. Similarly, when transferring information from the DVD 4a to the hard disc 3a, the information is output from the DVD-drive apparatus 4 to the HD-drive apparatus 3 according to a control signal as described above.

### (II) EMBODIMENT 1

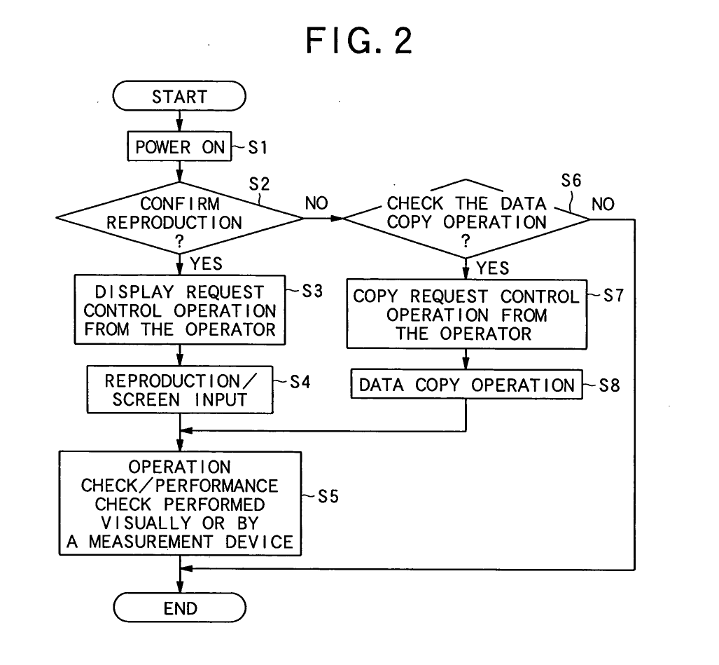

Next, the information reproduction process of a first embodiment of the invention will be explained using FIG. 1 and FIG. 2. FIG. 2 is a flowchart showing the entire recording and reproduction processes of this embodiment.

In the embodiment described below, the procedure for using operation-check data when copied information (hereafter, the initialized information and copied information will all be referred to as initialized information) and operation-check data are written simultaneously when initializing the hard disc 3a that is mounted in the HD-drive apparatus 3 in the manufacturing process of the information recording/reproduction apparatus R, and when copying the initialized information and the software for controlling the information recording/reproduction apparatus R to the hard disc 3a, will be explained.

In other words, this embodiment performs a function check of the information recording/reproduction apparatus R during the manufacturing process of the information recording/reproduction apparatus R, or after repairing trouble with the information recording/reproduction apparatus R.

As shown in FIG. 2, the power to the information recording/reproduction apparatus R is turned ON in step S1 when performing the function check of this embodiment.

In step S2, when performing the function check of the information recording/reproduction apparatus R again (step S2: YES), the process advances to step S3, and when the function check of the information recording/reproduction apparatus R is not to be performed again (step S2: NO), the process advances to step S6.

In step S3, in order to perform the control operation again, the operator performs key input (not shown in the figures) from the input unit 7 or remote-control unit 5. The keys for performing the control operation again are one or more keys that are set beforehand.

In step S4, the microcomputer unit 8 recognizes the key that was input in step S3, controls the HD-drive apparatus 3 such that it outputs the operation-check data written on the hard disc 3a to the output-interface unit 6. The output-interface unit 6 is connected to the display apparatus (not shown in the figure). The operation-check data that is written on the hard disc 3a is output from the output-interface unit 6 as a video signal Svo, which is the video information, and that video information is displayed on the display apparatus (not shown in the figures).

In step S5, the operator visually checks whether or not the video information displayed on the display apparatus is preset video information, or uses a measurement device (not shown in the figures) that recognizes the video information that is displayed on the display apparatus to determine whether or not the video information is preset video information.

In step S6, when writing (copying) the operation-check data on the hard disc 3a to another memory area of the hard disc 3a where the operation-check data is not written, or to a DVD 4a, the process advances to step S7. When the data is not to be copied, the operation ends.

In step S7, in order to perform copying, the operator performs key input (not shown in the figures) from the input unit 7 or remote-control unit 5. The keys for performing this copying operation are one or more preset keys.

In step S8, the microcomputer unit 8 recognizes the key(s) input in step S7 and controls the HD-drive apparatus 3 to write the operation-check data that is written on the hard disc 3a to another memory area on the hard disc 3a where the operation-check data is not written, or to a DVD 4a.

As explained above, during the manufacturing process of the information recording/reproduction apparatus R, when initializing the hard disc 3a (or when copying software), function-check information for checking the product is written at the same time. Therefore, on the production line, the work of initializing the hard disc 3a (or the work of copying software) is no longer performed separate from the work of writing the information for the function check, so it becomes possible to shorten the production time and simplify the work, as well as lower the manufacturing cost. Also, it becomes possible to check the operation of a repaired information recording/reproduction apparatus R by using operation-check data that was written at the time of manufacturing, so it is not necessary to prepare an apparatus for containing operation-check data that is separate from the information recording/reproduction apparatus R.

### (III) EMBODIMENT 2

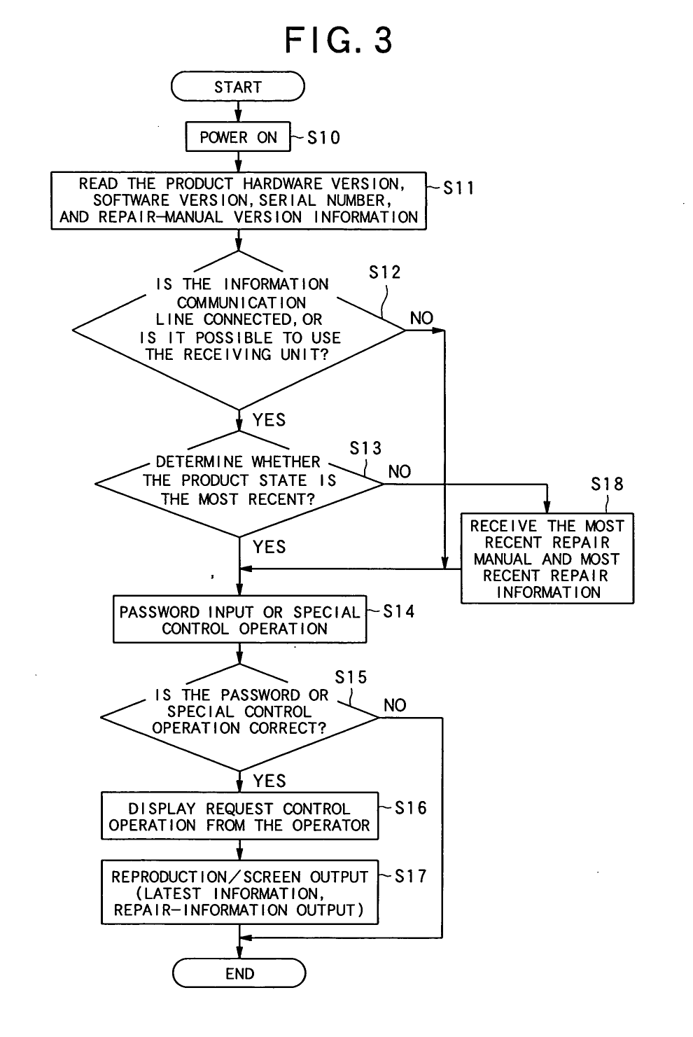

Next, FIG. 1 and FIG. 3 will be used to explain the information reproduction process of a second embodiment of the invention. FIG. 3 is a flowchart showing the overall reproduction process of this embodiment.

In the embodiment below, the procedure for using data when a repair manual and repair-information data are written simultaneously with initialization data when initializing the hard disc 3a mounted in the HD-drive apparatus 3 during the manufacturing process of the information recording/reproduction apparatus R, and the copy information when copying software onto the hard disc 3a for controlling the information recording/reproduction apparatus R will be explained (hereafter the initialization information and copy information will all be referred to as initialization information).

In other words, an embodiment of displaying hardware information or software information, or a repair manual for the information recording/reproduction apparatus R in the case of repairing the information recording/reproduction apparatus R will be explained.

As shown in FIG. 3, the power to the information recording/reproduction apparatus R is turned ON in step S10 when performing the display of this embodiment.

In step S11, the microcomputer unit 8 reads the hardware version, software version, product serial number and repair-manual version from the memory unit 9, HD drive 3 or DVD drive 4. After that, the process advances to step S12.

In step S12, the microcomputer unit 8 determines whether or not information can be sent or received from outside the information recording/reproduction apparatus R to an external-communications-interface unit 12 or receiving unit 2. When it is possible to send or receive information from the outside (step S12: YES), the process advances to step S13. When it is not possible to send or receive information from the outside (step S12: NO), the process advances to step S14.

In step S13, the microcomputer unit 8 determines from the hardware version, software version, product serial number and repair-manual version whether or not the repair manual and repair information recorded on the hard disc 3a are the most recent. When the repair manual and repair information are the most recent (step S13: YES), the process advances to step S14, however, when the repair manual and repair information are not the most recent (step S13: NO), the process advances to step S18.

In step S18, the most recent repair manual and repair information are input from outside the information recording/reproduction apparatus R by way of the communication-line-interface unit 12 or the receiving unit 2.

In step S14, the operator enters a password from the input unit 7 or remote-control unit 5, or performs a special control operation such as turning ON/OFF an internal switch in the information recording/reproduction apparatus R. After that, the process advances to step S15.

In step S15, the microcomputer unit 8 determines whether or not the value of the password input in step S14 or the special control operation is a preset password value or special control operation. When the value of the input password or special control operation is a preset password value or special operation (step S15: YES), the process advances to step S16, however, when it is not a preset password value or special control operation (step S15: NO), the process ends.

In step S16, in order to perform the reproduction control operation, the operator performs key (not shown in the figure) input from the input unit 7 or remote-control unit 5. The keys used for performing this reproduction control operation are one or more keys that are set beforehand.

In step S17, after the operator operates the input unit 7 or remote-control unit 5, the microcomputer unit 8 recognizes the input key and controls the HD-drive apparatus 3 such that it outputs the most recent repair manual or repair information that is written on the hard disc 3a to the output-interface unit 6. The display apparatus (not shown in the figure) is connected to the output-interface unit 6. The most recent repair manual or repair information that is written on the hard disc 3a is output from the output-interface unit 6 as a video signal Svo, and then that most recent repair manual or repair information is displayed on the display apparatus (not shown in the figure). The operator checks this information and is able to obtain the information related to repairing the information recording/reproduction apparatus R and parts to be repaired. Moreover, information related to repairing the information recording/reproduction apparatus R and parts to be repaired can be provided to the operator as audio information by way of speakers (not shown in the figure).

As explained above, the repair manual or repair information is written at the same time that the hard disc 3a is initialized during the manufacturing process of the information recording/reproduction apparatus R (or when copying software). As a result, the repair manual or repair information for the information recording/reproduction apparatus R is provided as images, so it is possible to provide the user with information that is more detailed and easier to understand than documents such as a manual.

Also, information about the information recording/reproduction apparatus R is provided as audio, so it is possible to provide the user with information that is more detailed and easier to understand than documents such as a manual.

Moreover, even when trouble with the information recording/reproduction apparatus R occurs in the market, by referencing part information for repairing the same model, it is possible to quickly identify the failed part.

### (IV) EMBODIMENT 3

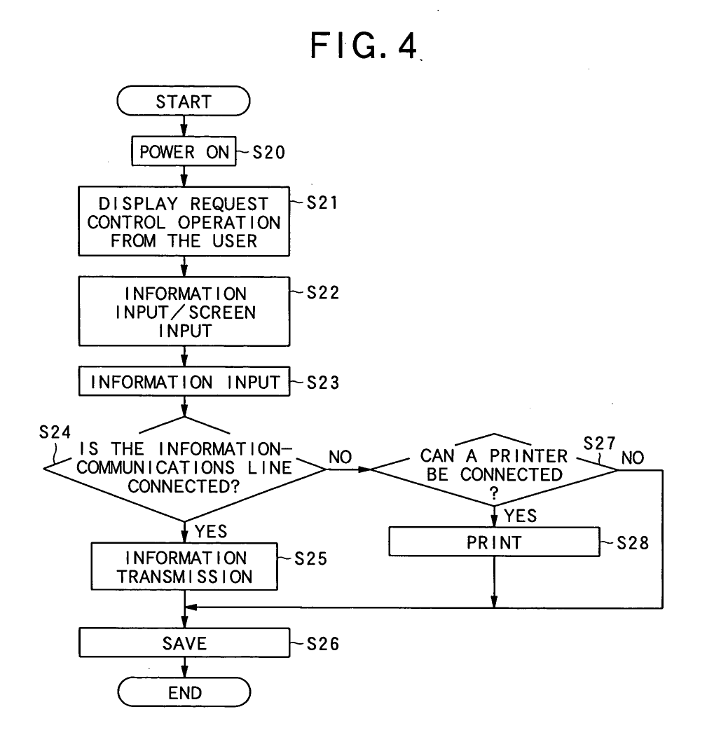

Next, FIG. 1 and FIG. 4 will be used to explain the information reproduction process of a third embodiment of the invention. FIG. 4 is a flowchart that shows the overall reproduction process of a fourth embodiment.

In this embodiment, the user-registration procedure that is performed by the user that purchased the information recording/reproduction apparatus R when the registration information related to the user-registration form is written simultaneously with initialization data when initializing the hard disc 3a mounted in the HD-drive apparatus 3 during the manufacturing process of the information recording/reproduction apparatus R, and the copy information when copying software onto the hard disc 3a for controlling the information recording/reproduction apparatus R will be explained (hereafter the initialization information and copy information will all be referred to as initialization information).

In other words, when using the information recording/reproduction apparatus R after purchasing it, the type of information that can be provided from the outside via the telephone-line-interface unit 12 or the receiving unit 2 is restricted based on the user-registration information for the information recording/reproduction apparatus R. To change the type of information that can be provided from the outside it is necessary to newly perform the user registration. The procedure for performing the user registration of this embodiment will be explained.

As shown in FIG. 4, when performing the user registration of this embodiment, the power to the information recording/reproduction apparatus is turned ON in step S20.

In step S21, in order for the user to perform user registration, the user enter one or more preset keys (not shown in the figure) from the input unit 7 or remote-control unit 5 in order to display the registration application information that is recorded on the hard disc 3a. After that, the process advances to step S22.

In step S22, after the operator operates the input unit 7 or remote-control unit 5, the microcomputer unit 8 recognizes the input key(s) and controls the HD-drive apparatus 3 such that it outputs the registration application information that is written on the hard disc 3a to the output-interface unit 6. The display unit (not shown in the figure) is connected to the Interface unit 6. The registration application information that is written on the hard disc 3a is output from the output-interface unit 6 as a video signal Svo, and that user-registration form is displayed on the display apparatus (not shown in the figure). After that, the process advances to step S23.

In step S23, while looking at the user-registration form displayed on the display apparatus, the user enters data required for the user-registration form by way of the input unit 7 or remote-control unit 5. After that, the process advances to step S24.

In step S24, the microcomputer unit 8 detects whether or not an information-communications line outside of the information recording/reproduction apparatus R is connected with the information recording/reproduction apparatus R via the external-communications-line-interface unit 12. When the external information-communications line and the information recording/reproduction apparatus R are connected (step S24: YES), the process advances to step S25. When the external information-communications line and the information recording/reproduction apparatus R are not connected (step S24: NO), the process advances to step S27.

In step S25, the information that was entered by the user in step S23 is sent to the external communications line of the information recording/reproduction apparatus R by way of the external-communications-line-interface unit 12. The information that is sent, is sent to the management department that manages user registration. After that, the process advances to step S26.

In step S26, the information that was entered by the user in step S23 is written and saved on the hard disc 3a according to control from the microcomputer unit 8.

In step S27, the microcomputer unit 8 determines whether or not a printer (not shown in the figure) is connected to the information recording/reproduction apparatus R. When a printer is connected to the information recording/reproduction apparatus R, the process advances to step S28. When there is no printer connected to the information recording/reproduction apparatus R, the process returns to step S26.

In step S28, the printer prints the information that was entered by the user in step S23 according to control from the microcomputer unit 8.

As was explained above, it is not necessary to supply a user-registration form in the form of a document or external memory medium with the information recording/reproduction apparatus R that is separate from the information recording/reproduction apparatus R, so management of the shipping of the product is simplified. Also, the user does not have to spend time looking for the documents that contain the user-registration forms, so it becomes easier for the user to perform user registration.

### (V) EMBODIMENT 4

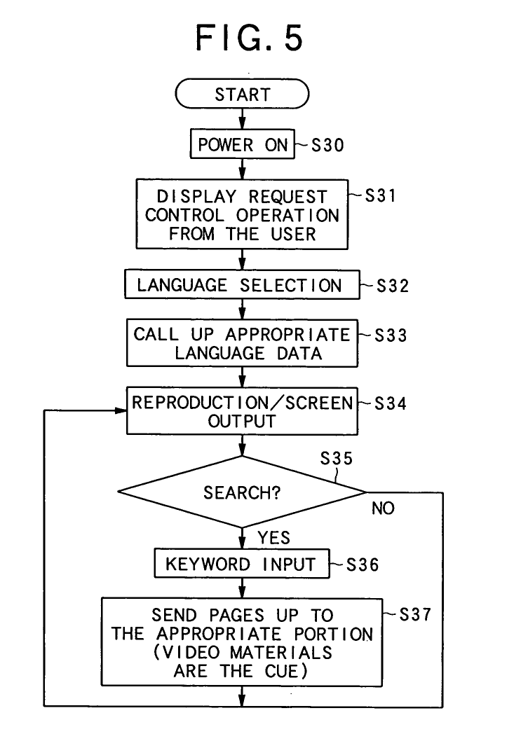

Next, FIG. 1 and FIG. 5 will be used to explain a fourth embodiment of the information reproduction process of this invention. FIG. 5 is a flowchart showing the overall reproduction process of this embodiment.

In this embodiment the method of displaying an operation manual and set-up instructions for the information recording/reproduction apparatus R when the Japanese or foreign language of the operation manual and set-up instructions for the information recording/reproduction apparatus R is written simultaneously with initialization data when initializing the hard disc 3a mounted in the HD-drive apparatus 3 during the manufacturing process of the information recording/reproduction apparatus R, and the copy information when copying software onto the hard disc 3a for controlling the information recording/reproduction apparatus R will be explained (hereafter the initialization information and copy information will all be referred to as initialization information).

As shown in FIG. 5, when displaying the operation manual or set-up instructions for the information recording/reproduction apparatus R of this embodiment, the power to the information recording/reproduction apparatus R is turned ON in step S30.

In step S31, in order to display the operation manual and set-up manual for the information recording/reproduction apparatus R, the user enters one or more preset keys (not shown in the figure) from the input unit 7 or remote-control unit 5 in order to display the operation manual and set-up instructions that are recorded on the hard disc 3a. After that, the process advances to step S32.

In step S32, the user selects the language from the input unit 7 or remote-control unit 5. After that, the process advances to step S33.

In step S33, based on the language selected in step S32, the microcomputer unit 8 controls the HD-drive apparatus 3 to read the hard disc 3a on which the information related to the operation manual and set-up manual for the information recording/reproduction apparatus R is recorded. After that, the process advances to step S34.

In step S34, the microcomputer unit 8 recognizes the key(s) input by the user in steps S31 and S32, and controls the HD-drive apparatus 3 to output the operation manual and set-up instructions for the information recording/reproduction apparatus R that are written on the hard disc 3a to the output-interface unit 6. A display apparatus (not shown in the figure) is connected to the output-interface unit 6. The operation manual and set-up instructions for the information recording/reproduction apparatus R that are written on the hard disc 3a are output from the output-interface unit 6 as a video signal Svo, and displayed on the display apparatus (not shown in the figure). After that, the process advances to step S35.

In step S35, the microcomputer unit 8 determines whether or not there is information to be searched for. When there is information to be searched for (step S35: YES), the process advances to step S36. When there is no information to be searched for (step S35: NO), the process returns to step S34.

In step S36, the operator uses the input unit 7 or remote-control unit 5 to enter keywords to be searched for. After that, the process advances to step S37.

In step S37, based on the keywords entered by the user in step S36, the microcomputer unit 8 displays the portions of the pages of the operation manual or set-up instructions of the information recording apparatus R that correspond with the keywords on the display apparatus that is connected to the output-interface unit 6. After that, the process returns to step S34.

As explained above, since it is not necessary to supply the operation manual and set-up instructions for the information recording/reproduction apparatus R in documents or an external recording medium separate from the information recording/reproduction apparatus R itself, shipping management of the product is simplified. Also, it does not take time for the user to look for documents or the like in which the operations manual and set-up instructions are recorded. Moreover, by having a keyword-search function in the information recording/reproduction apparatus R, it becomes possible for the user to easily search for desired information.

### (VI) EMBODIMENT 5

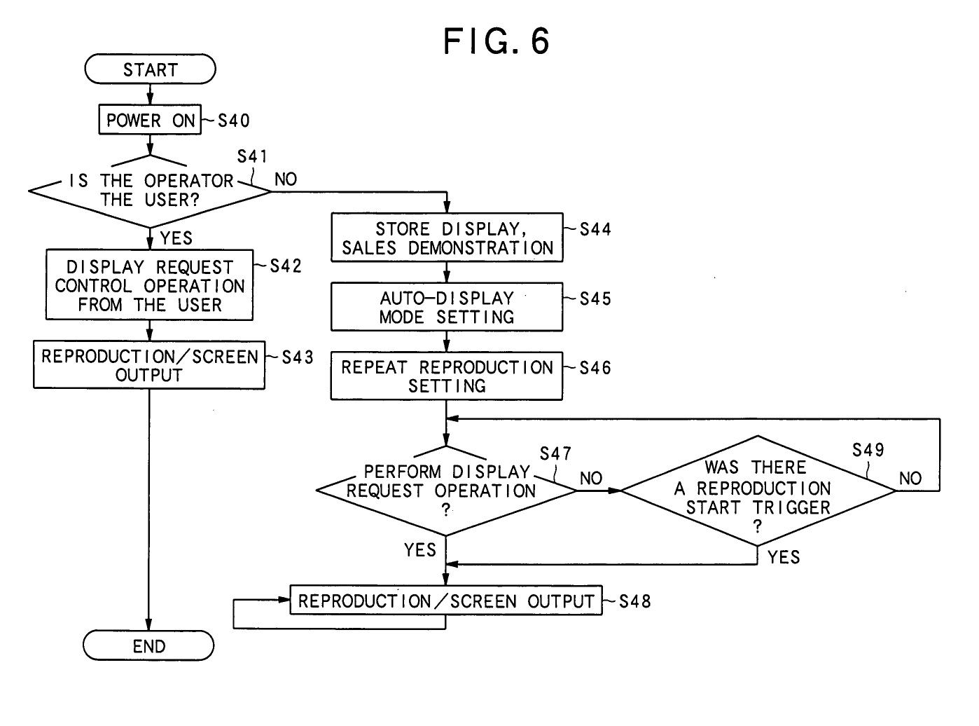

Next, FIG. 1 and FIG. 6 will be used to explain the information reproduction process of a fifth embodiment of the invention. FIG. 6 is a flowchart showing the overall reproduction process of this embodiment.

In the embodiment below, the display method by the information recording/reproduction apparatus R when product-advertisement information and related-product-advertisement information for the information recording/reproduction apparatus R are written simultaneously with initialization data when initializing the hard disc 3a mounted in the HD-drive apparatus 3 during the manufacturing process of the information recording/reproduction apparatus R, and the copy information when copying software onto the hard disc 3a for controlling the information recording/reproduction apparatus R will be explained (hereafter the initialization information and copy information will all be referred to as initialization information).

As shown in FIG. 6, when displaying product-advertisement information and related-product-advertisement information for the information recording/reproduction apparatus R, the power to the information recording/reproduction apparatus is turned ON in step S40.

In step S41, a password is entered from the input unit 7 or remote-control unit 5, or a special control operation such as turning ON/OFF an internal switch in the information recording/reproduction apparatus R is performed, and the microcomputer unit 8 determines whether or not the value of the password or the special control operation is a preset password value or preset operation. When the password value or special control operation is a preset password value or preset operation, the process advances to step S44, otherwise, the process advances to step S42.

Also, in step S41 it is also possible for the microcomputer unit 8 to determine whether or not user registration has been performed, and when registration has been performed, advance the process to step S42, however, when it registration has not been performed, it advances the process to step S44.

In step S42, key input from the input unit 7 or remote-control unit 5 is performed in order to display product-advertisement information or related-product-advertisement information. After that, the process advances to step S43.

In step S43, based on the key(s) input by the user in steps S41 and S42, the microcomputer unit 8 controls the HD-drive apparatus 3 such that the product-advertisement information or related-product-advertisement information for the user that is written on the hard disc 3a is output to the output-interface unit 6. A display apparatus (not shown in the figure) is connected to the output-interface unit 6. The product-advertisement information or related-product-advertisement information for the user that is written on the hard disc 3a is output from the output-interface unit 6 as a video signal Svo, and displayed on the display apparatus (not shown in the figure).

In step S44, the microcomputer unit 8 begins preparation to display the product-advertisement information or related-product-advertisement information for a store display or sales demonstration. After that, the process advances to step S45.

In step S45, the microcomputer unit 8 determines the input information of step S41, and turns ON or OFF the switch for performing an automatic display. After that, the process advances to step S46.

In step S46, the microcomputer unit 8 determines the input information of step S41, and turns ON or OFF the switch for repeating the display. After that, the process advances to step S47.

In step S47, the operator performs key input from the input unit 7 or remote-control unit 5, and in the case of displaying the product-advertisement information or related-product-advertisement information for a store display or sales demonstration on the display apparatus connected to the output-interface unit 6 (step S47: YES), the process advances to step S48. With the key(s) input by the user from the input unit 7 or remote-control unit 5 as a trigger, in the case of not displaying the product-advertisement information or related-product-advertisement information for a store display or sales demonstration on the display apparatus connected to the output-interface unit 6 (step S47: NO), the process advances to step S49.

In step S48, the microcomputer unit 8 recognizes the switches set by the operator in steps S45, S46 and S47, and controls the HD-drive apparatus 3 to output the product-advertisement information or related-product-advertisement information for a store display or sales demonstration written on the hard disc 3a to the output-interface unit 6. A display apparatus (not shown in the figure) is connected to the output-interface unit 6. The product-advertisement information or related-product-advertisement information for a store display or sales demonstration written on the hard disc 3a is output to the output-interface unit 6 as a video signal Svo, and displayed on the display apparatus (not shown in the figure).

In step S49, when a start reproduction instruction is input to the microcomputer unit 8 after a preset length of time has elapsed from the time the power is turned ON in step S40, or at a preset time that is set in the memory unit 9 from the input unit 7 or remote-control unit 5, or based on an instruction from an external device that is connected to the USB interface unit 11 or connected to the external-communications-line-interface unit 12, the process advances to step S48. When there is no instruction from an external device, the process advances to step S47.

As explained above, by having an information recording/reproduction apparatus R and an image-display apparatus, it is possible to readily perform advertisement for the information-reading/reproduction apparatus R, so when a customer is attracted to purchase a product, it is possible to effectively perform a presentation by the information-reading/reproduction apparatus R.

Furthermore, since it is not necessary to separately supply product-advertisement information or related-product-advertisement information for the user, store display or sales demonstration in the form of documents or external recording medium, shipping management of the product is simplified. Also, it does not take time for the user to fine the documents or the like so it becomes possible to easily check the operating method.

It is not necessary to transfer product-advertisement information or related-product-advertisement information for the user, store display or sales demonstration from an external device to the information recording/reproduction apparatus R, so it is possible to easily display and enjoy the appropriate information, or to perform a presentation.

### (VII) EMBODIMENT 6

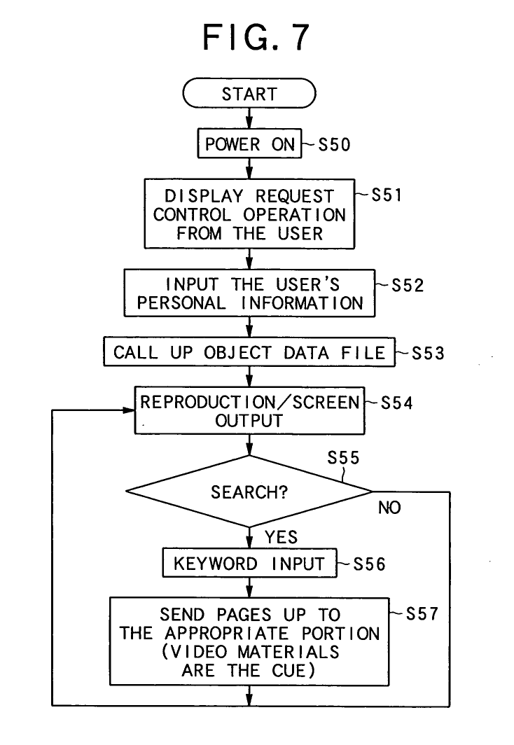

Next, FIG. 1 and FIG. 7 will be used to explain the information reproduction process of a sixth embodiment of the invention. FIG. 7 is a flowchart showing the overall reproduction process of this embodiment.

In the embodiment below, the display method by the information recording/reproduction apparatus R when advertisement-image information of an associated company related to the information recording/reproduction apparatus R is written simultaneously with initialization data when initializing the hard disc 3a mounted in the HD-drive apparatus 3 during the manufacturing process of the information recording/reproduction apparatus R, and the copy information when copying software onto the hard disc 3a for controlling the information recording/reproduction apparatus R will be explained (hereafter the initialization information and copy information will all be referred to as initialization information).

As shown in FIG. 7, when displaying advertisement-image information for an associated company related to the information recording/reproduction apparatus R of this embodiment, the power to the information recording/reproduction apparatus R is turned ON in step S50.

In step S51, the user enters one or more preset keys (not shown in the figure) from the input unit 7 or remote-control unit 5 in order to display advertisement-image information for an associated company related to the information recording/reproduction apparatus R that is recorded on the hard disc 3a. After that, the process advances to step S52.

In step S52, the user enters personal information such as age, sex, address, family composition, physical information, and the like from the input unit 7 or remote-control unit 5. After that, the process advances to step S53.

In step S53, based on the personal information input in step S52, the microcomputer unit 8 reads the advertisement-image information for the associated company related to the information recording/reproduction apparatus R recorded on the hard disc 3a by way of the HD-drive apparatus 3. After that, the process advances to step S54.

In step S54, the microcomputer unit 8 controls the HD-drive apparatus 3 based on the key(s) input by the user in steps S51 and S52 such that the it outputs the advertisement information for the associated company related to the information recording/reproduction apparatus R that is written on the hard disc 3a to the output-interface unit 6. A display apparatus (not shown in the figure) is connected to the output-interface unit 6. The advertisement information for the associated company related to the information recording/reproduction apparatus R that is written on the hard disc 3a is output from the output-interface unit 6 as a video signal Svo, and displayed on the display apparatus (not shown in the figure). After that, the process advances to step S55.

In step S55, the microcomputer unit 8 determines whether or not there is information to be searched. When there is information to be searched, the process advances to step S56. When there is no information to be searched, the process returns to step S54.

In step S56, the user uses the input unit or remote-control unit 5 to enter keywords to be searched. After that, the process advances to step S57.

In step S57, based on the keywords input by the user in step S56, the microcomputer unit 8 displays the portions of the pages that are were correlated in advance with the keywords of the advertisement information of the associated company related to the information recording/reproduction apparatus R on the display apparatus connected to the output-interface unit 6. After that, the process returns to step S54.

As was explained above, since it is not necessary to supply advertisement information of an associated company related to the information recording/reproduction apparatus R in the form of documents or external recording medium separate from the information recording/reproduction apparatus R, shipping management of the product is simplified. Also, for the user it becomes easy to display advertisement information of the associated company related to the information recording/reproduction apparatus R. Moreover, by having a keyword search function in the information recording/reproduction apparatus R, it is possible to easily search for desired information.

As was explained in each of the embodiments above, information related to the information recording/reproduction apparatus R itself is integrated with and stored on the hard disc 3a in the information recording/reproduction apparatus R, so it is not necessary to provide information related to the information recording/reproduction apparatus R on a separate medium, and thus there is no materials cost for the separate medium. Also, in the case of a separate medium, a storage place was necessary, however, there is no need for a storage place for a separate medium. Furthermore, in the case of providing information related to the information recording/reproduction apparatus R itself on a separate medium, there was the chance that the separate medium could be lost. However, in this case it is not necessary to look for the separate medium.

Also, the information related to the information recording/reproduction apparatus R is provided as images, so it is possible to provide information to the operator that is more detailed and easier to understand than through documents such as manuals.

Moreover, the information related to the information recording/reproduction apparatus R is provided as audio, so it is possible to provide information to the operator that is more detailed and easier to understand than through documents such as manuals.

Furthermore, function-check information for checking the product was written simultaneously with the initialization of the hard disc 3a in the manufacturing process of the information recording/reproduction apparatus. Therefore, since the work on the manufacturing line for initializing the hard disc 3a (or the work of copying software) is not performed separately from the work of writing function-check information, it is possible to shorten the manufacturing time, as well as simplify the work and lower the cost of manufacturing.

Also, by having an information recording/reproduction apparatus R and image-display apparatus, it is possible to readily perform advertisement for the information recording/reproduction apparatus R, so when a customer is attracted to purchasing the product, it is possible to effectively perform a presentation of the information recording/reproduction apparatus R.

Also, since it is not necessary to separately supply the operating method for the information recording/reproduction apparatus R using documents or an external recording medium, shipping management of the product is simplified. Moreover, the user does not have to spend time looking for the documents of the like in which the operating method is recorded, so it becomes easier to check the operating method.

Furthermore, even when trouble with the information recording/reproduction apparatus R occurs in the market, by referencing repair part information for the same model, it is possible to quickly identify the failed part.

This invention can also be applied to the case in which the two recording media of the information recording/reproduction apparatus are both hard discs 3a, and the program is transferred between them.

In addition, the invention can also be applied to the case in which at least one of the recording media is a semiconductor memory or a magnetic memory. In other words, it can be said that this invention is not limited by the recording medium and can be applied to all kinds of recording media.

It is possible to store programs that correspond to the flowcharts shown in FIG. 2 to FIG. 7 on an information recording medium such as a flexible disc, or to obtain those programs via a network such as the Internet and store it, and by reading those programs using a general-purpose microcomputer, that general-purpose microcomputer can be used as the microcomputer unit 8 of the embodiments described above.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-341485 filed on Sep. 30, 2003 including the specification, claims, drawings and summary are incorporated herein by reference in its entirety.

1. An information recording/reproduction apparatus comprising:
a first recording area on a recording medium that constantly records recording information input from the outside;
a first reproduction device which reproduces at least said information while recording it in said first recording area, or information that was recorded in said first recording area;
a second recording area on said recording medium in which information related to said information recording/reproduction apparatus itself is recorded;
a recording device which records said related information into said second recording area;
a specification device which is used for specifying said related information to be reproduced; and
a second reproduction device which reproduces said specified related information from said second recording area.

2. The information recording/reproduction apparatus according to claim 1 wherein
said related information is image information.

3. The information recording/reproduction apparatus according to claim 2 wherein
said related information includes information for checking the function of said information recording/reproduction apparatus, and is recorded together with the initialization information for initializing said first recording area in said second recording area.

4. The information recording/reproduction apparatus according to claim 2 wherein
said related information includes advertisement information for said information recording/reproduction apparatus itself.

5. The information recording/reproduction apparatus according to claim 1 wherein
said related information includes information related to the operating method of said information recording/reproduction apparatus itself.

6. The information recording/reproduction apparatus according to claim 1 wherein
said related information includes information for repairing said information recording/reproduction apparatus.

7. The information recording/reproduction apparatus according to claim 1 wherein
said related information includes information related to services that can be used by the operator of said information recording/reproduction apparatus.

8. The information recording/reproduction apparatus according to claim 1 wherein
said related information includes information that is configured using two or more languages.

9. An information recording/reproduction apparatus comprising:
a recording medium in which an information should be recorded;
a first reproduction device which reproduces said information that was recorded in said recording medium;
a specification device which is used for specifying a related information which relates to said information recording/reproduction apparatus itself; and
a second reproduction device which reproduces said specified related information from said recording medium, wherein
a recording information is input from the outside of the recording medium and said related information are recorded on said recording medium.

10. An information recording/reproduction apparatus according to claim 9, further comprising
a recording device which records said related information into said recording device.

11. An information recording/reproduction apparatus according to claim 9, wherein
said recording medium includes a first recording area in which recording information input from the outside to be recorded and a second recording area in which said related information to be recorded.

12. An information recording/reproduction method that is executed by an information recording/reproduction apparatus that comprises a first recording area on a recording medium that constantly records recording information that is input from the outside; and a first reproduction device which reproduces at least said information while recording it in said first recording area, or information that was recorded in said first recording area, the method comprising:
a recording process of recording related information that is related to said information recording/reproduction apparatus itself in a second recording area on said recording medium where said related information is recorded;
a specification process of specifying said related information to be reproduced; and
a second reproduction process of reproducing said specified related information from said second recording area.

13. An information recording/reproduction program that causes a computer included in an information recording/reproduction apparatus that comprises a first recording area on a recording that constantly records recording information that is input from the outside; and a first reproduction device which reproduces at least said information while recording it in said first recording area, or information that was recorded in said first recording area, to function as
a recording device which records related information that is related to said information recording/reproduction apparatus itself into a second recording area on said recording medium;
a specification device which is used for specifying said related information to be reproduced; and
a second reproduction device which reproduces said specified related information from the second recording area.

14. An information recording medium in which an information recording/reproduction program is recorded in a readable way by a computer included in an information recording/reproducing apparatus which comprises a first recording area on a recording medium that constantly records recording information that is input from the outside; and a first reproduction device which reproduces at least said information while recording it in said first recording area, or information that was recorded in said first recording area, the information recording/reproduction program causing the computer to function as:
a recording device which records related information that is related to said information recording/reproduction apparatus itself into a second recording area on said recording medium;
a specification device which is used for specifying said related information to be reproduced; and
a second reproduction device which reproduces said specified related information from the second recording area.
